(19) United States
(12) Patent Application Publication
(10) Pub. No.: US 2026/0179260 A1
(43) Pub. Date: Jun. 25, 2026

(54) DYNAMIC RENDERING OF ASSETS

(71) Applicant: Kyndryl, Inc., New York, NY (US)

(72) Inventor: CESAR AUGUSTO RODRIGUEZ BRAVO, ALAJUELA (CR)

(21) Appl. No.: 18/987,687

(22) Filed: Dec. 19, 2024

(51) Int. Cl. G06T 11/00

(52) U.S. Cl. CPC G06T 11/00

(57) ABSTRACT

Embodiments receive at least one input; determine a parameter value of each virtual asset within a metaverse; render at least one virtual asset within the metaverse based on the at least one input and the determined parameter value; and visually display the at least one rendered virtual asset to the metaverse.

### BACKGROUND

Aspects of the present invention relate generally to dynamically rendering of assets and, more particularly, to systems and methods for dynamically rendering of assets based on user attributes in metaverse environments.

In a metaverse, a system renders an identical environment to all avatars within the metaverse. For example, when an avatar enters a virtual venue, all of the avatars within the metaverse will see a same welcome banner at an entrance to the metaverse.

### SUMMARY

In a first aspect of the invention, there is a computer-implemented method including: receiving, by a computing device, at least one input; determining, by the computing device, a parameter value of each virtual asset within a metaverse; rendering, by the computing device, at least one virtual asset within the metaverse based on the at least one input and the determined parameter value; and visually displaying, by the computing device, the at least one rendered virtual asset to the metaverse.

In another aspect of the invention, there is a computer program product including one or more computer readable storage media having program instructions collectively stored on the one or more computer readable storage media. The program instructions are executable to: receive at least one input upon a user entering an environment; determine a parameter value of each virtual asset within the environment; render the at least one virtual asset within the environment based on the at least one input; and visually display the at least one rendered virtual asset such that different users within the environment view different renderings of the at least one virtual asset within the environment.

In another aspect of the invention, there is a system including a processor, a computer readable memory, one or more computer readable storage media, and program instructions collectively stored on the one or more computer readable storage media. The program instructions are executable to: receive at least one input upon a user entering a metaverse; determine a parameter value of each virtual asset within the metaverse; render the at least one first virtual asset within the metaverse based on the at least one input and the determined parameter value being dynamic; render the at least one virtual asset within the metaverse based on a default object value and the determined parameter value being static; and visually display the at least one rendered first virtual asset and the at least one rendered second virtual asset. In further aspects of the invention, different users within the metaverse simultaneously view different renderings of the least one first virtual asset within the metaverse.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of a dynamic asset rendering system in accordance with aspects of the present invention.

FIG. 5 shows a first example of a dynamic asset rendering within a metaverse in accordance with aspects of the present invention.

FIG. 6 shows an example of a static asset within a metaverse in accordance with aspects of the present invention.

FIG. 7 shows a second example of a dynamic asset rendering within a metaverse in accordance with aspects of the present invention.

FIG. 8 shows a third example of a dynamic asset rendering within a metaverse in accordance with aspects of the present invention.

FIG. 9 shows a fourth example of a dynamic asset rendering within a metaverse in accordance with aspects of the present invention.

FIG. 10 shows a fifth example of a dynamic asset rendering within a metaverse in accordance with aspects of the present invention.

FIG. 11 shows a flowchart of an exemplary method of the dynamic asset rendering system in accordance with aspects of the present invention.

FIG. 12 shows another flowchart of an exemplary method of the dynamic asset rendering system in accordance with aspects of the present invention.

FIG. 13 shows another flowchart of an exemplary method of the dynamic asset rendering system in accordance with aspects of the present invention.

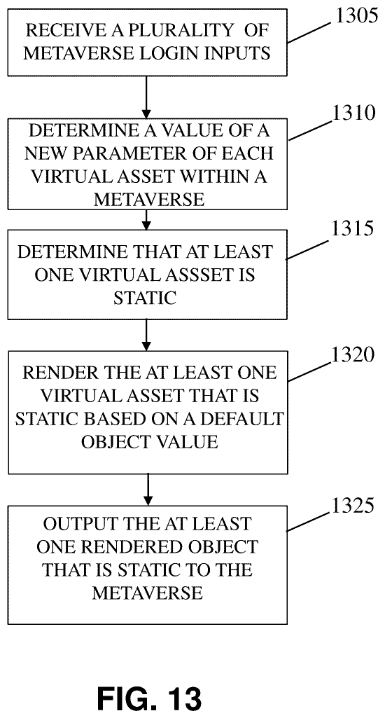

### DETAILED DESCRIPTION

Aspects of the present invention relate generally to dynamically rendering of assets and, more particularly, to systems and methods for dynamically rendering of assets based on user attributes in metaverse environments. Aspects of the present invention may be implemented as a system, method, or computer program product. The system, method, or computer program product creates a morphing environment based on a user attribute, time attribute, or other attributes that define a rendering of each asset in a metaverse. Accordingly, the system, method, and/or computer program product changes the rendering of assets in response to any change of user attributes. For example, the system, method, and/or computer program product displays a banner with a logo in the metaverse based on an email address that is used to login to the metaverse. Although embodiments may be described with reference to metaverse environments, embodiments may be directed to any artificial reality, virtual reality, or extended reality environment. The systems and methods provided herein may be computer implemented methods.

More specifically, the system, method, or computer program product described herein enables the selective and dynamic rendering of assets based on different attributes in metaverse environments. These attributes may include, for example, user attributes, environmental attributes, and available metadata which are stored in a dynamic rendering database. In this scenario, the system, method, or computer program product renders virtual assets based on the different attributes stored in the dynamic rendering database. Further, the system, method, or computer program product determines whether an object is fixed (e.g., the same for everyone) or dynamic (e.g., changes based on a plurality of attributes) in response to a value of a parameter and can render the virtual asset in the metaverse based on the parameter having a value of the dynamic parameter. Accordingly, embodiments of the present invention dynamically render a virtual environment within the metaverse differently for each user based on the plurality of attributes in response to a user entering the metaverse.

Embodiments of the present invention provide a technical solution of dynamically rendering at least one virtual asset differently for each user within a metaverse based on a plurality of attributes and a parameter of the at least one virtual asset. Accordingly, the technical solution addresses a technical problem of displaying a same virtual asset to each user within the metaverse. Further embodiments of the present invention provide a computer-implemented method, a system, and a computer program product to adjust rendering of objects in real-time within a metaverse environment based on a set of user characteristics and attributes. In aspects of the present invention, the computer-implemented method, the system, and the computer program product adjusts rendering of an object in real-time within the metaverse environment based on a set of environmental attributes and factors.

In contrast, known systems render a same environment to all users within a metaverse. In an example, known systems display a same welcome banner to all users at an entrance of a metaverse in response to a user entering the metaverse. However, known systems are not able to create a dynamic environment for different users within the metaverse based on a plurality of attributes (e.g., environment attributes, user attributes, metadata, etc.). The systems, methods, and computer program products as described herein make improvements on the known systems by enabling the present invention to dynamically change at least one virtual asset (e.g., an object) for each user within the metaverse based on the plurality of attributes and a parameter of the at least one virtual asset.

Implementations of the present invention are also rooted in computer technology. For example, determining that at least one virtual asset within a metaverse is dynamic based on a determined value of a parameter value and rendering the at least one virtual asset that is dynamic within the metaverse based on a plurality of metaverse login inputs are computer-based and cannot be performed in the human mind or with pen and paper. For example, the above noted functionality by definition are performed by a computer and cannot practically be performed in the human mind (or with pen and paper) due to the fact that at least one virtual asset is rendered within a metaverse. Given the scale and complexity of rendering at least one asset that is dynamic within a metaverse such that different users within the metaverse view different renderings of the at least one asset, amongst other features described herein, it is simply not possible for the human mind or for a person using pen and paper to render the at least one virtual asset dynamically in real-time and dynamically render the at least one virtual asset in real-time differently for each user within the metaverse; instead, these features, amongst other features described herein, are root in computer technology.

It should be understood that, to the extent implementations of the invention collect, store, or employ personal information provided by, or obtained from, individuals (for example, metaverse users), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models Are As Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

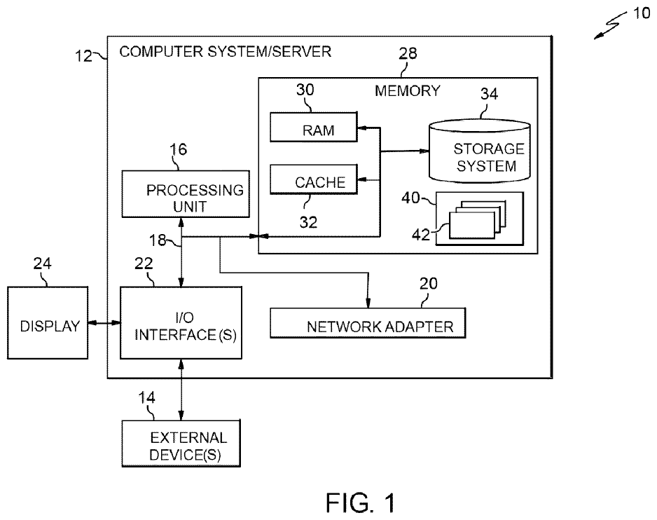

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc. ; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

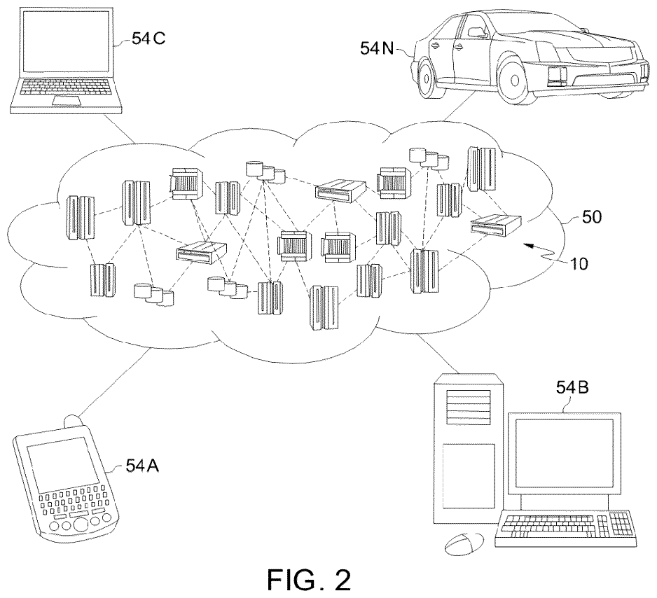

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

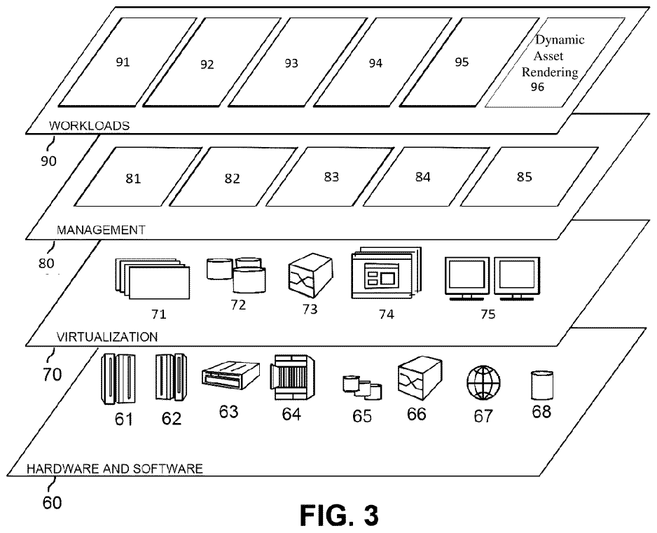

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dynamic asset rendering 96.

Implementations of the invention may include a computer system/server 12 of FIG. 1 in which one or more of the program modules 42 are configured to perform (or cause the computer system/server 12 to perform) one of more functions of the dynamic asset rendering 96 of FIG. 3. For example, the one or more of the program modules 42 of the dynamic asset rendering 96 may be configured to: receive a plurality of metaverse login inputs; determine a value of a parameter value of each virtual asset within a metaverse; determine that the least one virtual asset within the metaverse is dynamic based on the determined value of the parameter value being dynamic; render the at least one virtual asset that is dynamic within the metaverse based on the plurality of metaverse login inputs; and output the at least one rendered virtual asset that is dynamic to the metaverse.

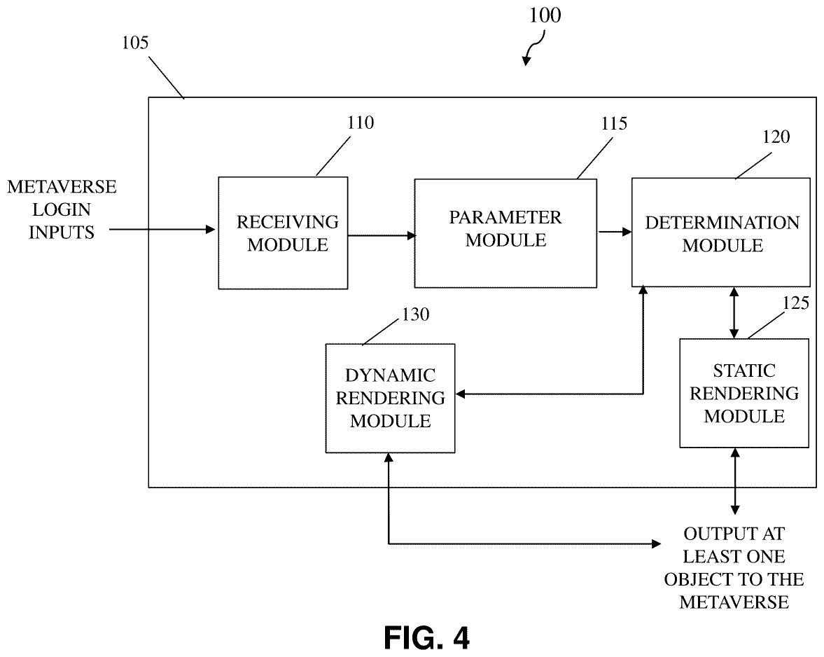

FIG. 4 shows a block diagram of a dynamic asset rendering system in accordance with aspects of the invention. In embodiments, the dynamic asset rendering system 100 comprises a dynamic asset rendering environment 105 which includes a receiving module 110, a parameter module 115, a determination module 120, a static rendering module 125, and a dynamic rendering module 130, each of which may comprise one or more program modules such as program modules 42 described with respect to FIG. 1 and the dynamic asset rendering 96 of FIG. 3.

The dynamic asset rendering system 100 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments of FIG. 4, the dynamic asset rendering system 100 enables the system, method, and computer-program product to select and dynamically render virtual assets based on a plurality of attributes in a metaverse environment. In particular, the dynamic asset rendering system 100 dynamically changes at least one virtual asset within the metaverse environment based on any number of different attributes (e.g., user attributes, environmental attributes, other metadata, etc.) and a parameter of the at least one virtual asset having a value of a dynamic parameter.

In embodiments, the receiving module 110 receives a plurality of metaverse login inputs associated with a user in response to the user entering a metaverse. In aspects of the present invention, the user entering the metaverse is represented by an avatar of the user entering the metaverse. In particular, the receiving module 110 analyzes the plurality of metaverse login inputs to gather a plurality of attributes and metadata. For example, the plurality of metaverse login inputs comprise at least one of an email account associated with the user, a user expertise, or an account type associated with the user.

In aspects of the present invention, the receiving module 110 receives the plurality of metaverse login inputs comprising the email account associated with the user. In this scenario, the receiving module 110 analyzes the email account associated with the user to determine a company or other association of the user. In an example, the receiving module 110 receives the plurality of metaverse login inputs comprising user1@kyndryl. com and determines that the company of the user is Kyndryl. In another example, the receiving module 110 receives the plurality of metaverse login inputs comprising user1@XYZ. com and determines that the company of the user is XYZ. The receiving module 110 sends the determined company or other association to the parameter module 115.

In aspects of the present invention, the receiving module 110 can also receive the plurality of metaverse login inputs comprising an expertise associated with the user. In this scenario, the receiving module 110 analyzes the user expertise to determine whether the user is a new user or an experienced user. In an example, the receiving module 110 determines that the user is a new user in response to determining that the user has not previously entered the metaverse. In this situation, the receiving module 110 determines that the user has not previously entered the metaverse based on a comparison of the user entering the metaverse with historical logins of the metaverse.

In another example, the receiving module 110 determines that the user is an experienced user in response to determining that the user has previously entered the metaverse a number of times above a predetermined login threshold. In this situation, the receiving module 110 determines that the user has previously entered the metaverse a number of times above the predetermined login threshold based on a comparison of the user entering the metaverse with the historical logins of the metaverse.

In embodiments, the predetermined login threshold may comprise at least ten logins such that the user entering the metaverse is determined to be an experienced user in response to determining that the user has entered the metaverse at least ten previous times. However, embodiments are not limited to ten logins, and the predetermined login threshold may be a variable value that can be set by a metaverse administrator. The receiving module 110 sends the user expertise to the parameter module 115.

In further aspects of the present invention, the receiving module 110 receives the plurality of metaverse login inputs comprising the account type associated with the user. In this scenario, the receiving module 110 analyzes the account type associated with the user to determine whether the account type associated with the user is a free account, a first premium tier account, a second premium tier account, etc. In an example, the receiving module 110 determines that the account type associated with the user is a free account, first premium tier account, etc., in response to comparing the account type with the historical logins of the metaverse. In aspects of the present invention, the second premium tier account is a more expensive tiered account than the first premium tier account. However, embodiments are not limited to first and second premium tier accounts, and any number of premium tier accounts can be set by the metaverse administrator. The receiving module 110 sends the verified account type to the parameter module 115.

In further embodiments, the receiving module 110 receives the plurality of metaverse login inputs comprising a time zone associated with a user in response to the user entering a metaverse. In this scenario, the receiving module 110 analyzes the time zone associated with the user to verify whether the time zone associated with the user is correct based on the location of the user. The receiving module 110 determines the location of the user based on an internet protocol (IP) address and compares the time zone associated with the user to the IP address to verify the correct time zone associated with the user. The receiving module 110 sends the verified time zone to the parameter module 115.

In further embodiments, the receiving module 110 also gathers environmental attributes comprising a language of an operating system (OS) of the metaverse. In aspects of the present invention, the user entering the metaverse sets the language of the OS of the metaverse. In further aspects of the present invention, the administrator of the metaverse sets a default language of the OS. The receiving module 110 sends the language of the OS to the parameter module 115.

In embodiments of the present invention, the parameter module 115 determines a value of a new parameter of each virtual asset (e.g., virtual object) within the metaverse. In embodiments, the value of the new parameter of each virtual asset (e.g., virtual object) is one of a static value or a dynamic value. In aspects of the present invention, the static value corresponds with the virtual asset being static and the same for everyone; whereas the dynamic value corresponds with the virtual asset being dynamic. In response to the virtual asset being dynamic, the virtual asset is rendered differently for each user of the metaverse based on the plurality of attributes (e.g., user attributes, environmental attributes, metadata, etc.) The parameter module 115 sends the value of the new parameter of each virtual asset (e.g., one of a static value and a dynamic value) and the information received from the receiving module 110 to the determination module 120.

In aspects of the present invention, the determination module 120 receives the information from the receiving module 110 and the value of the new parameter of each virtual asset via the parameter module 115. For example, the determination module 120 determines whether each virtual asset is static or dynamic based on the value of the new parameter of each virtual asset. The determination module 120 sends the static value of each virtual asset which has the static value of the new parameter to the static rendering module 125. Similarly, the determined module 120 sends the dynamic value of each virtual asset which has the dynamic value of the new parameter and the information from the receiving module 110 to the dynamic rendering module 130.

In aspects of the present invention, the static rendering module 125 renders each virtual asset which has the static value to a default object value in response to receiving the static value of each virtual asset which has the static value of the new parameter. In this scenario, the static rendering module 125 renders each virtual to a same default object value for each virtual asset. For example, the static rendering module 125 may render a welcome banner object to a default welcome message so that the welcome banner object displays the same message (i.e., the default welcome message) to all users who enter the metaverse. In further embodiments, the static rendering module 125 outputs at least one virtual asset which has the static value with the default object value to the metaverse.

In further aspects of the present invention, the dynamic rendering module 130 renders each virtual asset differently based on the dynamic value. In an example, the dynamic rendering module 130 renders each virtual asset with a particular company name based on the information from the receiving module 110 (i.e., based on the email associated with the user entering the metaverse). In another example, the dynamic rendering module 130 renders each virtual asset with a particular user expertise based on the information from the receiving module 110 (i.e., based on the number of logins of the user entering the metaverse). In another example, the dynamic rendering module 130 renders each virtual asset with a different verified account type based on the information from the receiving module 110 (i.e., based on whether the account type is a free account, a first premium account type, or a second premium account type).

In an example of FIG. 4, the dynamic rendering module 130 renders each virtual asset with the verified time zone based on the information from the receiving module 110 (i.e., based on the verified time zone of the user entering the metaverse). For example, the rendered virtual asset in the metaverse environment may be dark based on the time zone of the user entering the metaverse being at night. On the other hand, the rendered virtual asset in the metaverse may be light based on the time zone of another user entering the metaverse occurring during daytime. Accordingly, in embodiments, the rendered virtual asset is rendered differently (e.g., the rendered virtual asset is in the dark or in the light) to at least two different users who are simultaneously in the metaverse at the same time.

The dynamic rendering module 130 also renders each virtual asset with the language of the OS from the receiving module (i.e., based on the language of the OS within the metaverse) based on how the user sets the language of the OS when entering the metaverse (or previously sent the language of the OS during a previous login). For example, the rendered virtual asset in the metaverse environment may be a welcome banner of Bienvenido for a user which has set the language of Spanish within the OS of the metaverse. In another example, the rendered virtual asset in the metaverse may be a welcome banner of Welcome for a user which set the language of English within the OS of the metaverse. Accordingly, in embodiments, the rendered virtual asset is rendered differently (e.g., the rendered virtual asset displays a welcome banner of Welcome and Bienvenido) to two different users who are simultaneously in the metaverse at the same time.

In further embodiments, the dynamic rendering module 130 renders each virtual asset based on a resource source (e.g., a first resource placeholder of a Bienvenido banner or a second resource placeholder of a Welcome banner) and not based on a translation between languages. In further embodiments, the dynamic rendering module 130 outputs at least one rendered virtual asset which has the dynamic value to the metaverse.

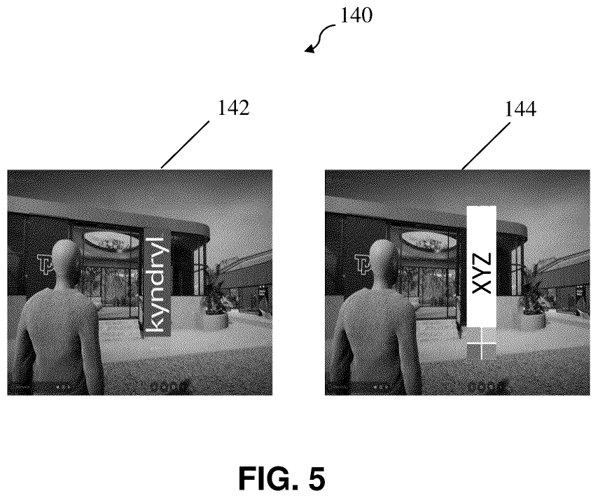

FIG. 5 shows a first example of a dynamic asset rendering within a metaverse in accordance with aspects of the present invention. In the first example of the dynamic asset rendering 140 within the metaverse, the dynamic rendering module 130 renders a virtual asset (e.g., a welcome banner) with a Kyndryl logo 142 based on a user entering the metaverse having an email address associated with the company (i.e., john.smith@kyndryl.com). The dynamic rendering module 130 also renders the virtual asset with a XYZ logo 144 based on another user entering the metaverse having the email address associated with the company (i.e., john.smith@XYZ.com). In the first example of the dynamic asset rendering 140 within the metaverse, both users are simultaneously within the metaverse and see different rendered virtual assets (e.g., the object with the Kyndryl logo 142 and the object with the XYZ logo 144) at the same time.

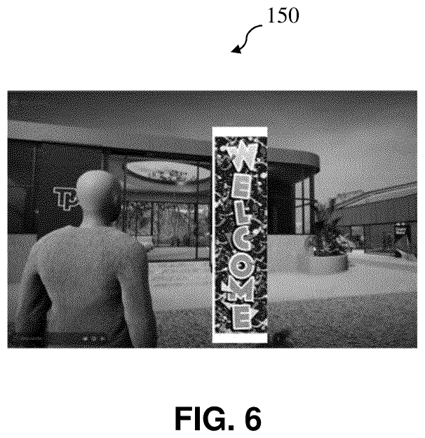

FIG. 6 shows an example of a static asset within a metaverse in accordance with aspects of the present invention. In the example of the static asset rendering 150, the static rendering module 125 renders the virtual asset (e.g., the welcome banner) with a static welcome message that is shown to all users within the metaverse.

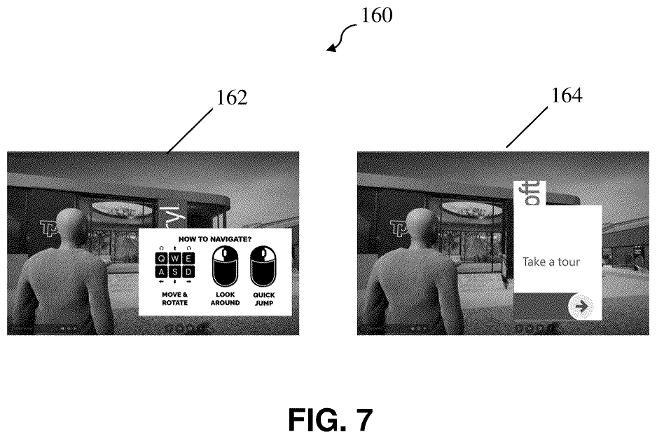

FIG. 7 shows a second example of a dynamic asset rendering within a metaverse in accordance with aspects of the present invention. In the second example of the dynamic asset rendering 160 within the metaverse, the dynamic rendering module 130 renders a virtual asset (e.g., a navigation object) with a how to navigate interface 162 based on the user entering the metaverse being a new user. The dynamic rending module 130 also renders the virtual asset with a take a tour interface 164 based on the user entering the metaverse being an experienced user. However, embodiments are not limited to navigation and take a tour interfaces, and may also include a map, a welcome message, etc.

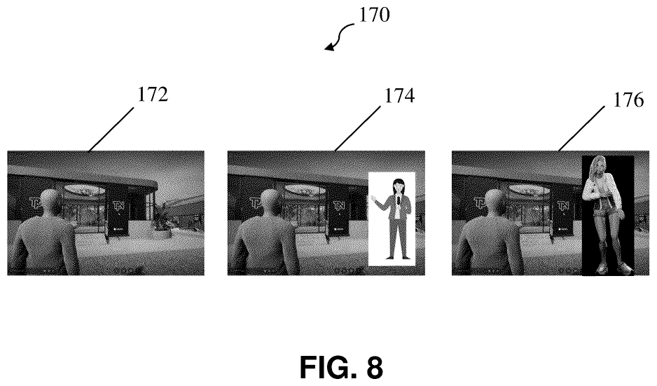

FIG. 8 shows a third example of a dynamic asset rendering within a metaverse in accordance with aspects of the present invention. In the third example of the dynamic asset rendering 170 within the metaverse, the dynamic rendering module 130 renders a virtual asset without a virtual host 172 based on the user having a free account. In an example, the visibility of virtual assets may be set to OFF (e.g., without a virtual host 172) for the free account. The dynamic rendering module 130 also renders the virtual asset with a 2D static virtual host 174 based on the user having a first premium account. The dynamic rendering module 130 also renders the virtual asset with a 3D animated virtual host 176 based on the user having a second premium account. In aspects of the present invention the second premium account is a higher tiered premium account than the first premium account and each of the renders would be shown to different users in the same metaverse.

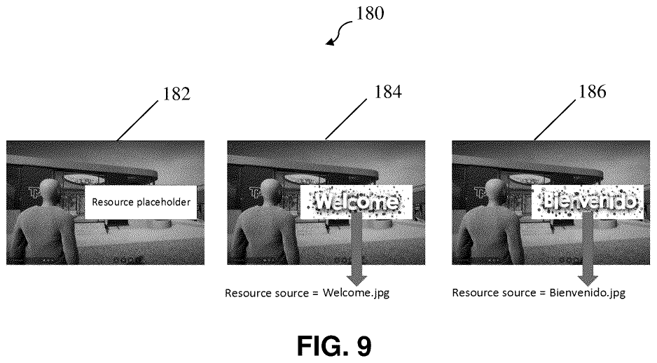

FIG. 9 shows a fourth example of a dynamic asset rendering within a metaverse in accordance with aspects of the present invention. In the fourth example of the dynamic asset rendering 180 within the metaverse, the dynamic rendering module 130 renders a virtual asset with a resource placeholder 182 based on the language of the OS. In particular, the dynamic rendering module 130 renders the virtual asset with a welcome banner 184 based on the user setting the language of the OS to be English. The dynamic rendering module 130 renders the virtual asset with a Bienvenido banner 186 based on the user setting the language of the OS to be Spanish.

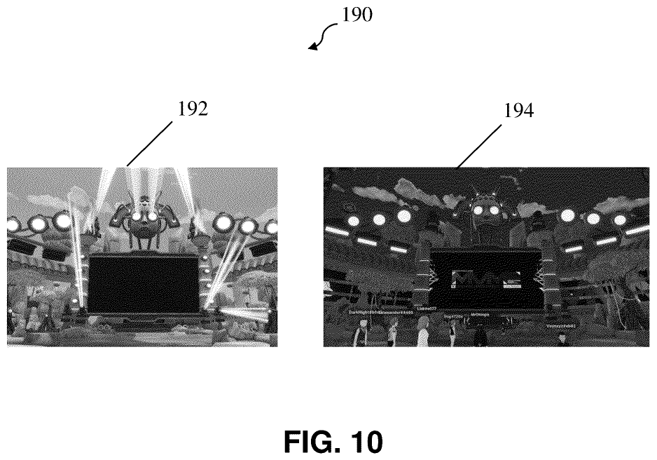

FIG. 10 shows a fifth example of a dynamic asset rendering within a metaverse in accordance with aspects of the present invention. In the fifth example of the dynamic asset rendering 190 within the metaverse, the dynamic rendering module 130 renders a virtual asset with a light theme 192 based on the time zone of the user entering the metaverse occurring during the day. The dynamic rendering module 130 also renders the virtual asset with a dark theme 194 based on the time zone of another user entering the metaverse during the night. As in each of the embodiments, both users may be within the metaverse at the same time and observe the different rendered virtual asset at the same time (e.g., in this example, the object with the light theme 192 and the object with the dark theme 194). For example, one of the users may be located in India during the night and another one of the users may be located in South America early in the morning. In this scenario, the user located in India may have the virtual asset with an adjusted lighting and overall environment corresponding with a time in India and another user located in South America may have the virtual asset with the adjusted lighting and the overall environment corresponding with a time in South America.

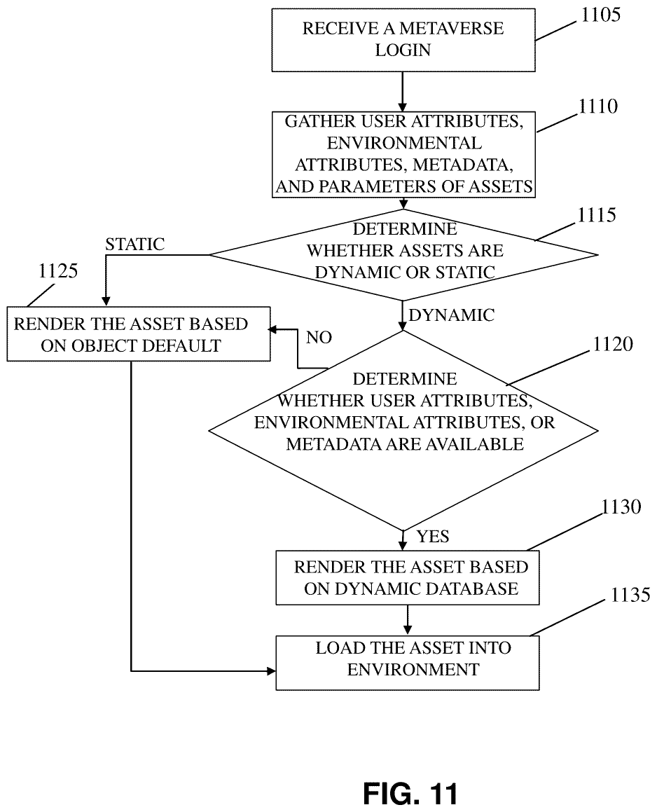

FIG. 11 shows a flowchart of an exemplary method of the dynamic asset rendering system in accordance with aspects of the present invention. Steps of the method may be carried out in the dynamic asset rendering environment 105 of FIG. 4.

At step 1105, the system receives, at the receiving module 110, a metaverse login associated with a user. In embodiments and as described with respect to FIG. 4, the metaverse login associated with a user includes a plurality of metaverse login inputs including user attributes, metadata, etc.

At step 1110, the system gathers, at the receiving module 110 and the parameter module 115, user attributes, environmental attributes, metadata, and parameters of assets, etc. At step 1115, the system determines, at the determination module 120, whether the assets are dynamic or static. If the asset is dynamic, at step 1120, the system determines, at the determination module 120, whether the user attributes, the environmental attributes, the metadata, and the parameters of assets are available in response to determining that the assets are dynamic in step 1115. In embodiments and as described with respect to FIG. 4, the determination module 120 also stores at least one of the user attributes, the environmental attributes, the metadata, and the parameter of assets in a dynamic database in response to determining that the at least one of the user attributes, the environmental attributes, the metadata, and the parameter of assets are available.

If the asset is static at step 1115 or the determination is negative at step 1120, at step 1125, the system renders, at the static rendering module 125, the asset based on an object default in response to determining that the assets are static in step 1115 or determining that none of the user attributes, the environmental attributes, the metadata, and the parameter of assets are available in step 1120. At step 1130, the system renders, at the dynamic rendering module 130, the asset based on the at least one of the user attributes, the environmental attributes, the metadata, and the parameter of assets being stored in the dynamic database. At step 1135, the system outputs, at one of the static rendering module 125 and the dynamic rendering module 130, the asset into the environment. In aspects of the present invention, the environment may be one of a metaverse, an augmented reality, a virtual reality, and an extended reality.

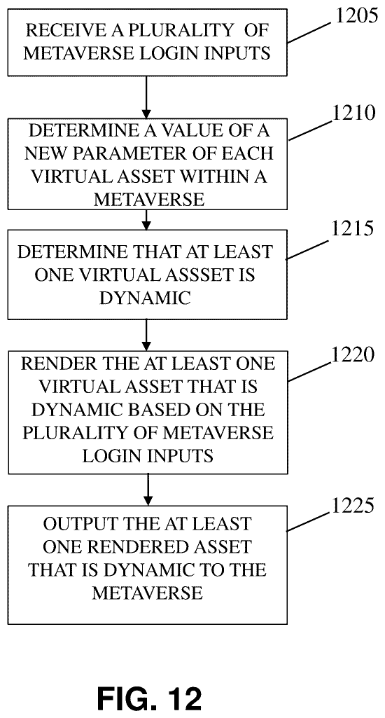

FIG. 12 shows another flowchart of an exemplary method of the dynamic asset rendering system in accordance with aspects of the present invention. Steps of the method may be carried out in the dynamic asset rendering environment 105 of FIG. 4.

At step 1205, the system receives, at the receiving module 110, a plurality of metaverse login inputs associated with a user. In embodiments and as described with respect to FIG. 4, the plurality of metaverse login inputs comprise at least one of an email account associated with the user, a user expertise, an account type associated with the user, or a time zone associated with the user.

At step 1210, the system determines, at the parameter model 115, a value of a new parameter of each virtual asset within the metaverse. In embodiments and as described with respect to FIG. 4, the value of the new parameter of each virtual asset within the metaverse is a static value or a dynamic value.

At step 1215, the system determines, at the determination model 120, that at least one virtual asset is dynamic. In embodiments and as described with respect to FIG. 4, the determination module 120 sends the dynamic value of the at least one virtual asset and the plurality of metaverse login inputs to the dynamic rendering module 130.

At step 1220, the system renders, at the dynamic rendering module 130, the at least one virtual asset that is dynamic based on the plurality of metaverse login inputs. In embodiments and as described with respect to FIG. 4, the dynamic rendering module 130 renders the at least one virtual asset differently for users in the metaverse which have different metaverse login inputs.

At step 1225, the system outputs, at the dynamic rendering module 130, the at least one rendered virtual asset that is dynamic to the metaverse. In embodiments and as described with respect to FIG. 4, the dynamic rendering module 130 outputs (e.g., visually displays) the at least one rendered virtual asset that is dynamic to the metaverse so that the at least one rendered virtual asset is visually displayed within the metaverse to a plurality of metaverse users.

FIG. 12 shows a flowchart of an exemplary method of the carbon footprint ecovision system in accordance with aspects of the present invention. Steps of the method may be carried out in the carbon footprint ecovision environment of FIG. 4.

At step 1305, the system receives, at the receiving module 110, a plurality of metaverse login inputs associated with a user. In embodiments and as described with respect to FIG. 4, the plurality of metaverse login inputs comprise at least one of an email account associated with the user, a user expertise, an account type associated with the user, or a time zone associated with the user.

At step 1310, the system determines, at the parameter model 115, a value of a new parameter of each virtual asset within the metaverse. In embodiments and as described with respect to FIG. 4, the value of the new parameter of each virtual asset within the metaverse is one of a static value and a dynamic value.

At step 1315, the system determines, at the determination model 120, that at least one virtual asset is static. In embodiments and as described with respect to FIG. 4, the determination module 120 sends the static value of the at least one virtual asset to the static rendering module 125.

At step 1320, the system renders, at the static rendering module 125, the at least one virtual asset that is static based on an object default value (e.g., fixed image). In embodiments and as described with respect to FIG. 4, the static rendering module 125 renders the at least one virtual asset the same for all users in the metaverse.

At step 1325, the system outputs, at the static rendering module 125, the at least one rendered virtual asset that is static to the metaverse. In embodiments and as described with respect to FIG. 4, the static rendering module 125 outputs the at least one rendered virtual asset that is static to the metaverse so that the at least one rendered virtual asset is visually displayed within the metaverse to a plurality of metaverse users.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computing device, at least one input;
determining, by the computing device, a parameter value of each virtual asset within a metaverse;
rendering, by the computing device, at least one virtual asset based on the at least one input and the determined parameter value; and
visually displaying, by the computing device, the at least one rendered virtual asset.

2. The computer-implemented method of claim 1, wherein the at least one input comprises at least one metaverse input which includes at least one of an email account associated with a user, a user expertise, an account type associated with the user, or a time zone associated with the user.

3. The computer-implemented method of claim 2, wherein the rendering comprises a static rendering based on an object default value.

4. The computer-implemented method of claim 3, wherein the static rendering is common to multiple users and includes a fixed static image that does not change.

5. The computer-implemented method of claim 2, wherein the rendering comprises a dynamic rendering that is unique to each user based on a user attribute.

6. The computer-implemented method of claim 5, wherein the user attribute is obtained from an email address associated with the user.

7. The computer-implemented method of claim 5, wherein the user attribute comprises at least one of the user expertise or the account type associated with the user.

8. The computer-implemented method of claim 7, wherein the account type comprises at least one of a free account or a premium account.

9. The computer-implemented method of claim 4, wherein the dynamic rendering provides a different rendering for different users within the metaverse viewing an object at a same time.

10. The computer-implemented method of claim 1, further comprising:
determining, by the computing device, whether at least one of user attributes, environmental attributes, or metadata are available;
rendering, by the computing device, the at least one virtual asset based dynamically in response to at least one of the user attributes, the environmental attributes, or the metadata being available; and
loading, by the computing device, the dynamic virtual asset into an environment.

11. The computer-implemented method of claim 10, further comprising:
rendering, by the computing device, the at least one virtual asset based on an object default value; and
loading, by the computing device, the at least virtual asset into the environment in response to rendering the at least one virtual asset based on the object default value.

12. A computer program product comprising one or more computer readable storage media having program instructions collectively stored on the one or more computer readable storage media, the program instructions executable to:
receive at least one input upon a user entering a computer generated environment;
determine a parameter value of each virtual asset within the computer generated environment;
render the at least one virtual asset within the computer generated environment based on the at least one input and the determined parameter value; and
visually display the at least one rendered virtual asset such that different users within the environment view different renderings of the at least one virtual asset within the environment.

13. The computer program product of claim 12, wherein the at least one input comprises at least one of an email account associated with a user, a user expertise, an account type associated with the user, or a time zone associated with the user.

14. The computer program product of claim 13, wherein the rendering comprises a dynamic rendering that is based on a user attribute and which is unique to each user within the computer generated environment.

15. The computer program product of claim 14, wherein the user attribute is obtained from an email address associated with the user.

16. The computer program product of claim 14, wherein the user attribute is obtained from a user expertise associated with the user.

17. The computer program product of claim 16, wherein the user expertise corresponds with a new user or an experienced user.

18. The computer program product of claim 14, wherein the user attribute is obtained from the account type associated with the user.

19. The computer-program product of claim 12, wherein the environment comprises an extended reality.

20. A system comprising:
a processor, a computer readable memory, one or more computer readable storage media, and program instructions collectively stored on the one or more computer readable storage media, the program instructions executable to:
receive at least one input upon a user entering a metaverse;
determine a parameter value of each virtual asset within the metaverse;
render the at least one first virtual asset within the metaverse based on the at least one input and the determined parameter value being dynamic;
render the at least one second virtual asset within the metaverse based on a default object value and the determined parameter value being static; and
visually display the at least one rendered first virtual asset and the at least one rendered second virtual asset,
wherein different users within the metaverse simultaneously view different renderings of the at least one first virtual asset within the metaverse.
